(19) United States
(12) Patent Application Publication
(10) Pub. No.: US 2021/0131670 A1
(43) Pub. Date: May 6, 2021

(54) POWER CONTROL SYSTEMS AND METHODS

(71) Applicant: Brava Home, Inc., Redwood City, CA (US)

(72) Inventors: Kuy Mainwaring, Menlo Park, CA (US); Michael Constant, San Mateo, CA (US); Shih-Yu Cheng, Union City, CA (US); Dennis Denker, Scottsdale, CA (US)

(21) Appl. No.: 17/044,835

(22) PCT Filed: Mar. 14, 2019
(86) PCT No.: PCT/US2019/022363

§ 371 Date: Oct. 1, 2020

Related U.S. Application Data
(60) Provisional application No. 62/643,717, filed on Mar. 15, 2018.
(60) Provisional application No. 62/695,819, filed on Jul. 9, 2018.

(51) Int. Cl. F24C 7/08; A47J 37/06; A47J 36/32; H05B 1/02

(52) U.S. Cl. CPC F24C 7/087; A47J 37/0629; H05B 2203/035; H05B 1/0263; A47J 36/32

(57) ABSTRACT

Power control systems and methods include power control logic configured to selectively apply electrical power received from an external resource to a plurality of heating elements to implement a heating algorithm. In one embodiment, the power control logic is configured to measure the electrical power supplied to the plurality of heating elements, predict an amount of the electrical power needed to activate one or more of the plurality of heating elements, track power usage for each of the plurality of heating elements, and determine a next heating element to activate based on the tracked power usage and the heating algorithm. The system may include a voltage sense network to sense the electrical power received from the external resource and a high-power current-sense resistor to sense current flow through a circuit path supplying power to the plurality of heating elements

### CROSS-REFERENCE TO RELATED APPLICATIONS

This application claims priority to and the benefit of U.S. Provisional Application No. 62/643,717, filed Mar. 15, 2018, entitled “POWER CONTROL SYSTEMS AND METHODS,” and U.S. Provisional Application No. 62/695,819, filed Jul. 9, 2018, entitled “POWER CONTROL SYSTEMS AND METHODS,” each of which is incorporated by reference herein in its entirety.

This application is related to U.S. patent application Ser. No. 15/490,768, entitled “VARIABLE PEAK WAVELENGTH COOKING INSTRUMENT WITH SUPPORT TRAY,” which is incorporated by reference herein in its entirety.

### TECHNICAL FIELD

Various embodiments relate to power control systems and methods including, for example, systems and methods for controlling heating components in a cooking apparatus.

### BACKGROUND

Intelligent cooking systems have been introduced to assist unskilled cooks in the preparation of food. Some intelligent cooking systems are capable of implementing heating algorithms that allow for more complex recipes, faster cooking and/or more consistent results than typically available with conventional recipes and ovens. However, such systems are often subject to safety and other regulations that place limits on power consumption that can constrain the efficiency and capabilities of an intelligent cooking system. Further such electronic consumer devices are typically designed for use in a variety of environments with variable electrical power characteristics, which may include environments with lower than optimal power resources for operating heating elements of an intelligent cooking system. One solution would be to build an intelligent cooking system with low power heaters, but this solution is not desirable for high performance cooking systems. In view of the foregoing, there is a continued need for improved power control systems and methods for controlling heating components in an intelligent cooking system.

### SUMMARY

The present disclosure addresses various needs for improved power control systems and methods. In various embodiments, a device includes a processor operable to execute power control logic configured to selectively apply electrical power received from an external resource to a plurality of heating elements to implement a heating algorithm. The power control logic may be configured to measure the electrical power supplied to the plurality of heating elements, predict an amount of the electrical power needed to activate one or more of the plurality of heating elements, track power usage for each of the plurality of heating elements, and determine a next heating element to activate based on the tracked power usage and the heating algorithm.

The device may further include a voltage sense network operable to sense the electrical power received from the external resource, and the electrical power supplied to the plurality of heating elements may be measured from the sensed electrical power received from the external resource. The device may also include a high-power current-sense resistor operable to sense current flow through a circuit path supplying power to the plurality of heating elements, and the electrical power supplied to the plurality of heating elements may be measured from the sensed current flow. The device may also include a cooking engine to implement the heating algorithm to control the heating elements. The device may further include a plurality of TRIACs, each TRIAC electrically coupled to a corresponding one of the plurality of heating elements, and the processor may generate TRIAC drive control signals to selectively activate one of the plurality of TRIACs to drive a corresponding heating element.

In various embodiments, the power control logic is further configured to track a temperature of each of the plurality of heating elements based on the measured electrical power, wherein the predicted amount of the electrical power needed to activate one or more of the plurality of heating elements is based on a difference between a current tracked temperature and a desired temperature established by the heating algorithm. The power control logic may be further configured to maintain a ledger of power usage for each of the plurality of heating elements, wherein the ledger is updated every half cycle, and determine, based on the ledger, a next one of the plurality of heating elements to activate.

The power control logic may be further configured to selectively power the heating elements in accordance with the heating algorithm to achieve a heating objective, determine a time to measure the electrical power supplied to the plurality of heating elements, supply power to the selected heating element at the determined time, wherein the determined time is different than an activation time for the selected heating element in accordance with the heating algorithm, and adjust an amount of power supplied to the selected heating element in a subsequent cycle in accordance with the heating objective. Measurement error may vary during a heating cycle of the heating elements and the time to measure the electrical power may be determined to reduce measurement error. The power control logic may be configured to activate the selected heating element early in the heating cycle to get a measurement and compensate by reducing power applied in a next half cycle to maintain a desired power output. In some embodiment, the heating algorithm generates distortion in the measurements, and the power control logic is further configured to take a measurement later in a cycle and extrapolate backward in time to a moment when the heating element was turned on.

In some embodiments, a method includes regulating electrical power received from a power source, receiving at least one performance objective for a plurality of electrical power consuming components, and selectively delivering the electrical power to the plurality of electrical power consuming components to achieve the performance objective. In some embodiments, the electrical power consuming components may include a plurality of heating elements, and the performance objective may include heating an interior oven chamber in accordance with a heating algorithm.

In some embodiments, the method may further include measuring the electrical power supplied to the plurality of electrical power consuming components, predicting an amount of the electrical power needed to activate one or more of the plurality of electrical power consuming components, tracking power usage for each of the plurality of electrical power consuming components, and determining a next of the plurality of power consuming components to activate based on the tracked power usage and the performance objective. The method may further include tracking a temperature of each of the plurality of electrical power consuming component based on the measured electrical power, and the predicted amount of the electrical power needed to activate one or more of the plurality of electrical power consuming components may be based on a difference between a current tracked temperature and a desired temperature in accordance with the performance objective.

In some embodiments, the method further includes maintaining a ledger of power usage for each of the plurality of electrical power consuming components, wherein the ledger is updated every half cycle, and determining, based on the ledger, a next one of the plurality of electrical power consuming components to activate.

In some embodiments, the method may further include selectively powering the electrical power consuming components in accordance with the performance objective, determining a time to measure the electrical power supplied to the plurality of electrical power consuming components, supplying power to the selected electrical power consuming components at the determined time, wherein the determined time is different than an activation time for the selected electrical power consuming components in accordance with the performance objective, and adjusting an amount of power supplied to the selected electrical power consuming components in a subsequent cycle in accordance with the performance objective. The measurement error may vary during an activation cycle of the electrical power consuming components and the time to measure the electrical power may be determined to reduce measurement error.

In some embodiments, the method further includes predicting, based on measured power, a probability of a failure event, and reducing power consumption in response to the predicted probability of a failure event.

The scope of the present disclosure is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is a diagram illustrating a side cross-section view of a cooking apparatus, in accordance with various embodiments.

FIG. 2 is a diagram illustrating a power control circuit for controlling heating elements, in accordance with various embodiments.

FIG. 3 is a flowchart illustrating a method for controlling heating elements, in accordance with various embodiments.

FIGS. 4A-D are graphs illustrating exemplary phase-angle determinations, in accordance with various embodiments.

FIG. 5 is a diagram illustrating functional components of an exemplary cooking apparatus, in accordance with various embodiments.

FIG. 6 is a diagram illustrating a top view of a cooking apparatus, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

The present disclosure addresses various needs for improved power control systems and methods. In various embodiments, a power control system is operable to regulate the application of electrical power from a resource, deliver power to a variety of electrical power consuming components, and provide a variety of control capabilities for the application of electrical power to the resources. In some embodiments, a power control system is provided to control heating elements in a cooking apparatus.

In various embodiments disclosed herein, power control systems and methods for operating heating elements of an intelligent cooking system allow for more complex heating algorithms than available with manually operated conventional ovens. In a conventional oven, heating elements slowly heat the oven to a desired temperature for cooking. The food is then placed into the oven for a certain amount of time or until certain food characteristics are observed by the cook.

Intelligent cooking systems may implement more complex heating algorithms including heating at a plurality of wavelengths, adjusting the temperature at set times during the recipe, and adaptively and rapidly adjusting the applied power in response to sensor feedback. Some heating algorithms may call for the heating elements to be quickly turned on and off. Moving from “off” to “on” can cause a cooking system to consume power at increased rates due to the rapid cooling of a heating element when it is off and the power consumption requirements to turn the heating element on and bring the heating element to a steady-state of operation. However, internal system constraints and external environmental constraints may limit the power available to the intelligent cooking system, which may limit the heating algorithms that can be reliability implemented by an intelligent cooking system. For example, a heating algorithm may demand use of a substantial portion of the available power in order to cook food quickly or achieve a certain result (e.g., sear the food). The power control systems and methods disclosed herein address and overcome various internal and external environmental constraints, enabling more efficient and robust operation.

The power control systems and methods of the present disclosure further address various challenges to implementing high performance heaters, such as quartz-tungsten-halogen tubes (referred to herein as “QTH heaters”), in an intelligent cooking system. It is desirable in such systems to account for external variables that exist in various use cases. External constraints on power consumption may lead to undesirable results such as tripping circuit breakers, blowing fuses, and decreased performance of other devices sharing the same circuit (e.g., flickering lights when the intelligent cooking system is operated). In various embodiments, the intelligent cooking system may receive power from an external resource having one or more characteristics or limitations that affect the operation of the system. External characteristics may include variable root-mean-square (RMS) supply voltage, variable effective external resistance, total power draw available from the resource, and total current draw available from the resource. It may also be desirable for the intelligent cooking system to have access to as much power as possible without adversely affecting the external environment (e.g., external electrical circuits) in order to maximize the functionality of the intelligent cooking system to achieve faster cooking results and reliable delivery of heat as required by complex heating algorithms.

The QTH heaters add additional operational constraints to be addressed by the system, including highly variable effective impedance (or resistance). For example, the power expended heating a QTH heater to its steady-state operating temperature is quickly lost when the QTH heater stops receiving power. QTH heaters also need more power to go from room temperature to steady-state operating temperature and use a high amount of current when operating at relatively low power levels. In various embodiments, a heater's steady-state includes a desired, driven power balance, for a desired duration, between incoming power to the heater filament and power dissipated by the heater filament. The steady-state temperature includes the average temperature of the heater filament at a given desired, driven power balance.

In various embodiments disclosed herein, power control systems and methods address these and other constraints by measuring the current and/or voltage inbound to the device, controlling the applied power by variable phase control using a circuit, such as a circuit including TRIACs (triodes for alternating current), transistors, relays, FETs, etc., performing an accounting based on power that has been applied to each QTH heater in the recent past, and anticipating and modeling the characteristics of the heating elements and environment. In various embodiments, variable phase control determines an “on” time and/or an “off” time for each heating element to precisely control the power delivered to each heating element.

In various embodiments, the power control system controls the voltage applied to a load as a function of time. In various embodiments, the power control system controls voltage by turning a switch (e.g. a TRIAC, transistor, etc.) on and off. In various other embodiments, the power control system controls voltage by varying the voltage level (e.g., using a transistor, a tuned RC circuit, etc.). The power control system may be used for devices that are subject to various electronic constraints (e.g., instantaneous current, average current over specified time period, instantaneous voltage, average voltage over specified time period) when it is desirable or required to operate the device within those constraints. In some embodiments, current and voltage are measured directly and power is measured indirectly, and the power control system servos the desired current levels and desired power levels.

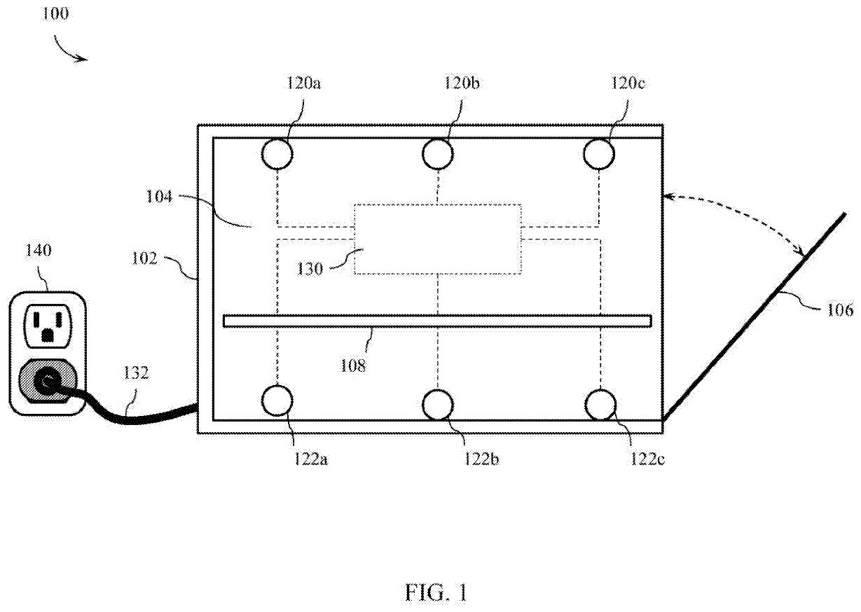

Referring to FIG. 1, an exemplary cooking appliance (e.g., a smart oven) will now be described. As illustrated, an oven 100 has a housing 102, an interior cooking chamber 104, and a door 106 providing access to the interior cooking chamber 104. The oven 100 also includes a plurality of heating elements for heating the oven, including top heating elements 120a, 120b and 120c, and bottom heating elements 122a, 122b, and 122c. The oven 100 further includes power control logic and circuitry 130, which may be embedded in the housing 102 of the oven for controlling the heating elements 120 and 122 during operation of the oven 100. Electrical power to the oven 100 may be provided by an external source 140, such as a wall outlet, through a power cable 132. In other embodiments, resources of electrical power may include power supplies, AC voltage sources operating at different voltages and frequencies, inverters and synthetic wave form generators, and coupled power sources.

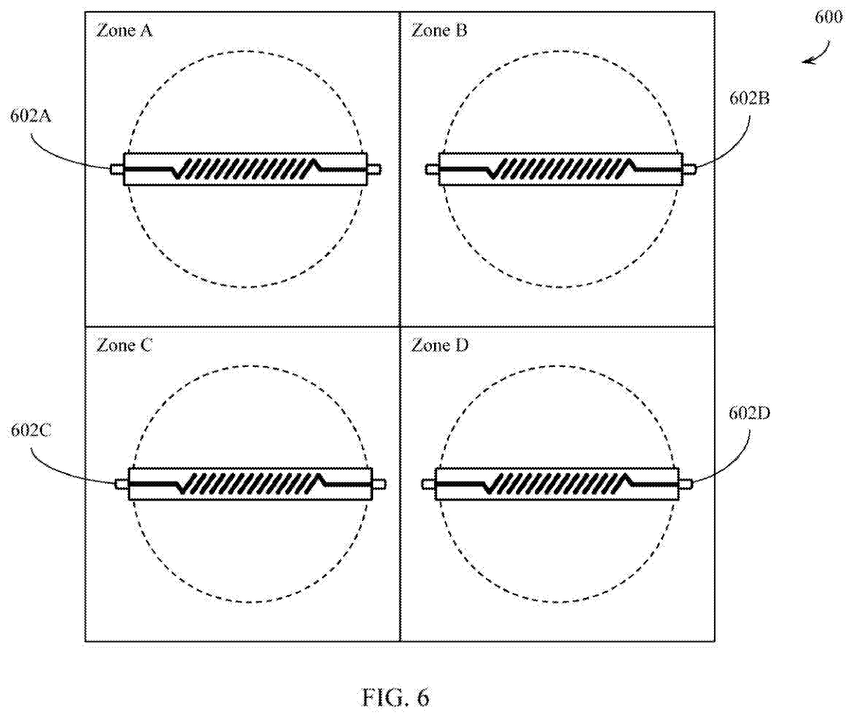

The heating elements 120 and 122 may be any heating components suitable for heating the oven 100. In various embodiments, the heating elements 120 and 122 are QTH heaters or other suitable heating elements which are used to heat the interior cooking chamber 104 for cooking. The power control logic and circuitry 130 regulates power delivery to the heating elements 120/122. In one embodiment, it is desirable to select QTH heaters which consume, at steady-state, the maximum allowed power of the product class for the oven 100. Although FIG. 1 shows an oven having six QTH heaters in an exemplary arrangement, it will be appreciated that the present disclosure applies to implementations with any number of heating elements which may be positioned in alternate arrangements, such as illustrated in FIG. 6.

In operation, the QTH heaters consume power and dissipate energy into the interior cooking chamber 104. The interior cooking chamber 104 may include a cooking tray 108 disposed such that heat generated by the QTH heaters can be applied to food placed on the cooking tray 108. The average power consumed (and thus the average power emitted) and the wavelength of light produced by each QTH heater is regulated by the power control logic and circuitry 130, and may also be affected by the overall power consumed by the oven, including operation of other components of the oven 100, such as sensors, cooking logic, user interfaces, and communications components.

Those skilled in the art will recognize that the use of quartz-tungsten-halogen heaters as heating elements in an oven poses several challenges which are overcome by the embodiments disclosed herein. One challenge is that the QTH heaters, on a transient basis, may instantaneously consume orders of magnitude more power to warm up to operating temperature from a current temperature (e.g., a room or other ambient temperature). The heating and cooling rates of the QTH heaters may be dependent upon the recent history of power applied to each QTH heater and the current temperature of each heater. Thus, when turned on from a cold state or while “on” while its filament temperature is relatively “low”, an unregulated QTH heater may consume many times the maximum allowed power. Another challenge is that when a QTH heater is not receiving power, it cools rapidly to ambient temperature, which increases the power required for the next activation of the QTH heater. Third, the expected service life of a QTH heater may be reduced to a duration shorter than desired if operated at too high a temperature (e.g., by applying too much power input). Fourth, when operating at low average power levels, a QTH heater may operate below a steady-state filament temperature, which decreases the filament's resistance compared to its steady-state resistance, thus causing the QTH heater to consume a larger amount of current than it would when operating at a steady-state filament temperature for a given voltage. Fifth, for a practical implementation in a consumer product, it may be desirable to select a QTH heater having a steady-state power that is close to the maximum allowed power of the product class to maximize performance; however, at any given time a single QTH heater may consume all current available to the set of QTH heaters, during which time the other QTH heaters will rapidly cool due to their inherent characteristics and will require additional power when reactivated.

In one embodiment, it is desirable to maximize the amount of power pulled from the available power source (e.g., external power source 140, such as a wall outlet in a home kitchen). In one embodiment, each heating element is designed to consume the entire current budget in its steady-state of operation. For example, if the oven 100 has a maximum current budget of 15 amps, then heating elements may be selected with each having a steady-state at 15 amps. In this manner, the oven 100 may concentrate all available current into a single heater which is on alone, or distribute it into multiple heaters which may be on concurrently.

As previously mentioned, one drawback of QTH heaters is that when the heater is cool (e.g., not consuming power and resting at room/ambient temperature) it is relatively conductive. At any given time, the instantaneous power required to bring the QTH heater up to steady-state operations may be orders of magnitude higher than the steady-state power requirements (e.g., 10x the steady-state power requirements). The QTH heaters take a lot of power to warm up and once the current is removed, the heater starts cooling off to ambient temperature (even if in a hot oven, the ambient temperature is a cold state for the device). Thus, the QTH heaters have limitations on power consumption at steady-state per safety and power consumption requirements for consumer devices, but are power hungry to start up and get up to steady-state. Operating an oven with these heating elements could (without a means for regulating the instantaneous current draw) require large amounts of current from the external power source 140 over a short period of time, which could cause fuses to blow, breakers to trip or other effects of exceeding operation power limits for the external environment.

The power control and logic circuitry 130 mitigates these and other issues by controlling the heating elements 120/122 to operate within the power constraints of the oven 100 and the external environment. In some embodiments, the power control and logic circuitry 130 will also keep each heating element 120/122 operating consistently within parameters that will extend the operational lifetime of the heating elements. Otherwise, small variations of voltage available from the external power source 140 (e.g., +/−10%) can negatively affect service life.

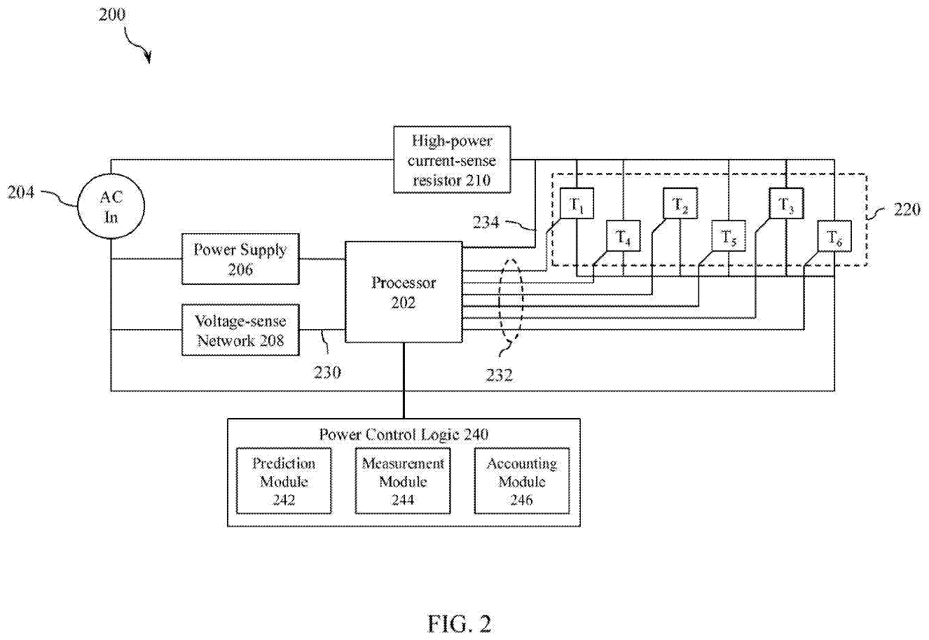

Referring to FIG. 2, an embodiment of a power control system 200 in accordance with various embodiments is illustrated. In one embodiment, the power control system 200 is implemented as an electrical circuit and includes an AC input 204, a power supply 206, a voltage sensing network 208 for measuring the main (AC) input voltage at a voltage measurement path 230 and frequency and phase (zero-crossing events). The power control system 200 also includes components (such as high-power current sense resistor 210) operable to measure current flow through a branch of the circuit (current sense measurement path 234) supplying all loads (e.g., QTH heaters 120/122 from FIG. 1 and their associated drive components 220). Both the measurement inputs and actuation outputs are connected directly to a processor 202 which is operable to interact with power control logic 240. In various embodiments, the power control logic may include a prediction module 242, a measurement module 244 and an accounting module 246, which may be implemented in one or more of analog circuitry, digital circuitry, firmware and/or software executed by the processor 202.

The power control system 200 is operable to measure the voltage of the power received from the external power source (e.g., an AC signal from a wall outlet) at voltage measurement path 230, and measure the current through the heating elements at current sense measurement path 234. The processor 202 is operable to generate drive control signals 232 to selectively activate the drive components 220, which may include one or more TRIACs T₁₋₆ (or other AC control component as may be implemented in other embodiments) to drive a corresponding heating element. The power control logic 240 receives the measures of voltage and current via measurement module 244, receives information from a heating algorithm concerning heating requirements, and selects an appropriate heating element to implement the heating algorithm. It will be appreciated that the heating elements may be configured for operation with the power control system 200 in variety of ways including, but not limited to, time multiplexed, serial and parallel arrangements. It will also be appreciated that the measuring components used in an implementation of the power control system 200 may operate with algorithms to compensate for variances in tolerances of current and voltage measuring components.

The accounting module 246 is configured to track power usage for each heating element, as well as the operational power requirements for the oven. In various embodiments, the accounting module 246 maintains a balance (also referred to herein as a ledger) for each heating element and adds the amount of power that has been delivered to each heating element every one half cycle (e.g., 120 Hz in U.S.). The accounting balance may be tracked through a window of time providing information regarding recent power usage (e.g., a first-in, first-out queue). After updating the ledger, the power control logic 240 determines one or more heating elements to activate next, which may include selecting the heating elements with the lowest power balance. The accounting module 246 additionally monitors the power requirements to be delivered by the heating elements and divides the power amongst selected heating elements at proportions required by the heating algorithm, while ensuring that power consumption remains below undesirably high levels. Alternatively, the power control logic 240 may be configured to implement additional heating element selection algorithms, which may include, for example, randomly selecting the next heating element to activate or a direct sequence of hopping between heating elements in a fixed order. However, these heating element selection algorithms do not provide the same advantages discussed herein with respect to power control logic of the present disclosure.

In various embodiments, the power control logic 240 is operable to automatically adjust the heating element selection based on the measured voltage received from the AC input 204. For example, if the input voltage drops (e.g., power received from a wall socket) then the power control logic 240 will still attempt to hit the same power targets. In one embodiment, if voltage decreases, the system will need more current so the system draws more current from the power source and then determines the phase-angle it needs to fire at to get that current. The power control logic 240 may determine the number of joules or volt-amperes it needed to deliver and compare it to how many were actually delivered. If the system needs more current to achieve its power targets, it will take more in the next half cycle.

In various embodiments, aspects of the power control system 200, including aspects of the power control logic 240, may be implemented in discrete digital electronics, analog electronics components and/or software. The processor 202 may execute program instructions stored in a memory to implement one or more logical processing algorithms described herein. In various embodiments, the power control system 200 includes a circuit such that the input voltage is rectified, the circuit including transistors. The power control system 200 may also use prior usage information to predict power needed to heat each heating element using the prediction module 242. The power control system 200 may model the electrical system such that physical simulation is used as a predictor of heating element performance.

In various embodiments, the power control system 200 regulates the amount of power delivered to each heating element by selecting when, and for how long, a switch that enables power to the heating element is turned on. For example, for a controlling AC signal 204, the time chosen may be a point in every half wave (or no point if a heating element is off) at which the switch (e.g., a TRIAC) is triggered. For other implementations (e.g., MOSFETs), the on and off times may be selected based on other constraints and requirements of the circuit components.

In the illustrated embodiment, which includes an AC supply and a plurality of TRIACs, “forward-phase” switching may be employed, wherein each TRIAC is turned “on” at a particular point in a half-wave (between two zero-crossings) and continues to be “on” until the next zero-crossing. In this embodiment, a zero-crossing is the point at which the line and neutral wires of the power cable are at the same voltage.

In the case of AC control using a plurality of TRIACs as the switching element, a turn-on phase is selected for each half-wave, or no phase if a heater is not to be activated on a given cycle. When the TRIAC is triggered, there is a non-trivial discontinuity in the measured voltage signal due to voltage loss on, at minimum, the product's power cord. Voltage drops from the external power resource (e.g., on the building's wiring) may also be significant (e.g., building wiring may be 500 mΩ to 1Ω in some locations). At the same instant, there is a discontinuity in the current signal as the heater goes from no current to full operating current. QTH heaters that are not close to their steady-state operating temperature will have a correspondingly low resistance and the current spike will therefore be of commensurately high magnitude for a given power level. Accordingly, the power signal will also spike.

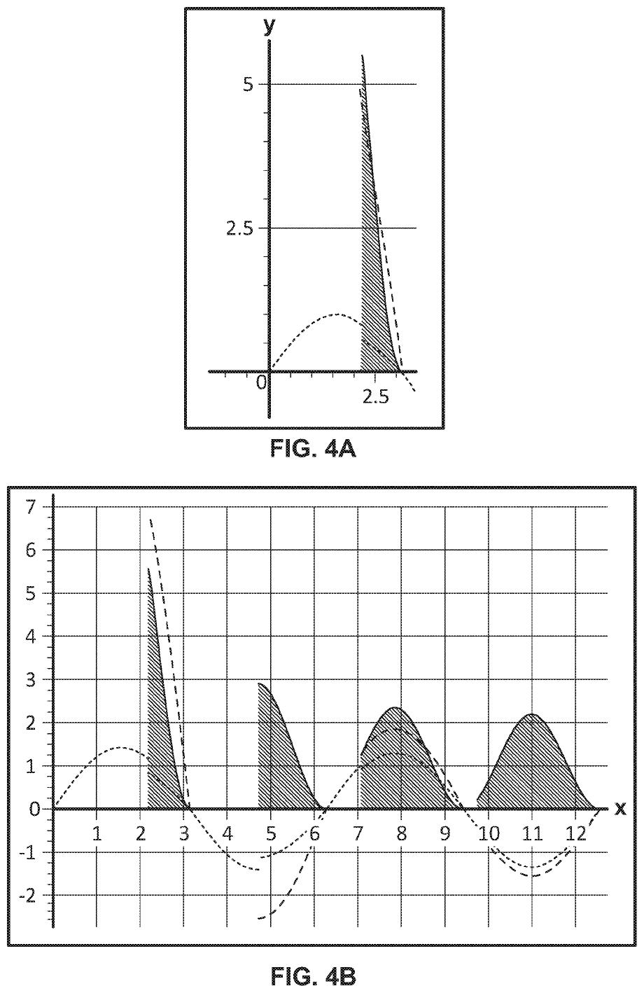

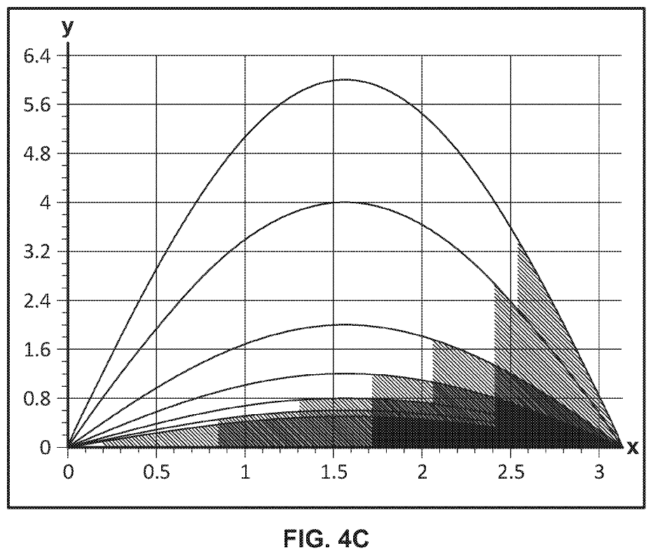

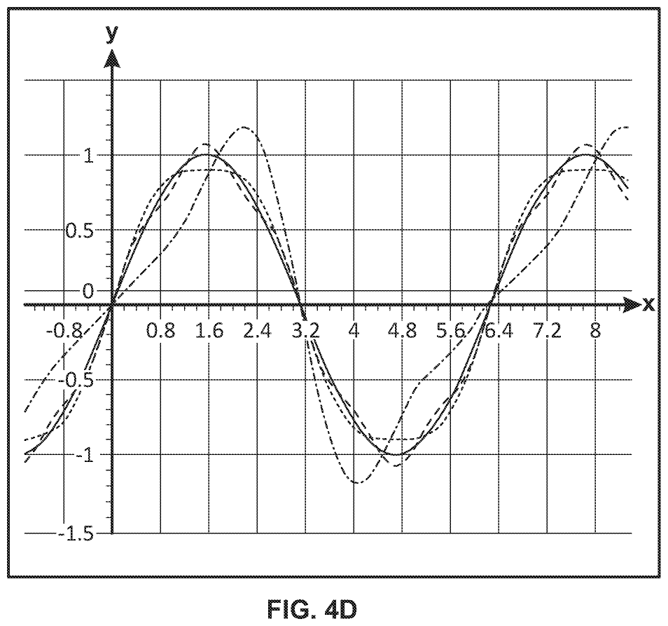

FIG. 4A is a graph illustrating an exemplary single half-wave with a turn-on phase of about 126°. FIG. 4B is a graph illustrating a changing phase-angle to handle dynamic load impedance conditions. As illustrated, the dotted curve represents the voltage signal, the dashed curve represents the current signal, the solid curve represents the power, and the shaded region represents energy.

As stated previously, QTH heaters have a resistance that varies with filament temperature. As each pulse of power is delivered into a QTH heater, the filament increases in temperature and its resistance increases (up to the point at which the filament has been driven to the desired power balance). Filament temperature increases until an equilibrium is struck between the power consumed by the QTH heater due to its filament resistance and the sum of power lost via radiation (in the form of infrared and visible light) and heating of the surrounding fluid medium (i.e., air). This equilibrium point, for a nominal DC or RMS AC operating voltage, is the steady-state condition. The nominal voltage is the product's expected operating voltage and frequency, and the nominal power of steady-state is the defined power of the product's QTH heaters, which may be chosen based on regulatory requirements for the product class.

### “Soft-Start”, Hot- and Cold-Start Conditions

The concept of a “soft-start” system may be considered as a basic solution to loads with high initial current requirements. Often these systems operate as an open-loop controlled fixed-duration sweep of low duty-cycle (or high phase-angle for TRIAC control) to high duty cycle (low phase-angle) to decrease initial power requirements. While this may work for an accelerating motor in, e.g., a vacuum cleaner, the requirement of keeping multiple QTH heaters at regulated power levels—particularly when those target power levels are continuously changing, as they do in a culinary application—is beyond the scope of conventional “soft-start” control.

In various embodiments disclosed herein, power control systems provide heater level phase control to effectively handle both “cold-start” cases where a QTH heater or other load starts from a highly current-demanding initial condition and transitions to a less current-demanding “hot” condition, as well as “hot-start” cases where the initial condition is less current-demanding than the “cold-start” case. It achieves this using its universal closed-loop control method of measuring power delivered in previous cycles and deciding how much, if any, to apply to the load in the next cycle. A typical “soft-start” system cannot handle these cases because it does not use measurement feedback to control the power delivered to a load.

Additionally, culinary applications may use multiple outer feedback loops to control power delivered to food items, such as feedback from temperature probes inserted into food items, from air temperature sensors, from image sensors, etc. As a result, the requested power levels of such systems may change often to achieve cooking objectives. The power control system with heater level phase control is well-suited to varying input power level requests.

In various embodiments, to be able to deliver a desired power level to a load (e.g., a kitchen appliance) it is desirable for the specification of the heater to be chosen such that it can deliver this power under worst-case practical conditions for the product. These conditions consist of the lowest RMS voltage, the highest building wiring resistance and the highest cooling rate of all heaters in the product. To satisfy these conditions, a practical product implementation may use heaters which would consume, e.g., more than 2200 W if plugged directly into household power sockets, for a desired power level of 1800 W to the load.

As the power control system with heater level phase control is able to continuously monitor supply voltage and current delivered to QTH heater loads, the system can vary the effective consumed current continuously as a function of available voltage. Additionally, such a system can automatically detect and adapt to the utility voltage of a 120V 60 Hz country and to a 230V 50 Hz country in the same product.

For implementations using MOSFET or SCR switch designs, the waveforms would be different but the control principle may be implemented as disclosed herein. Furthermore, the heater level phase control principle works on both AC and DC implementations.

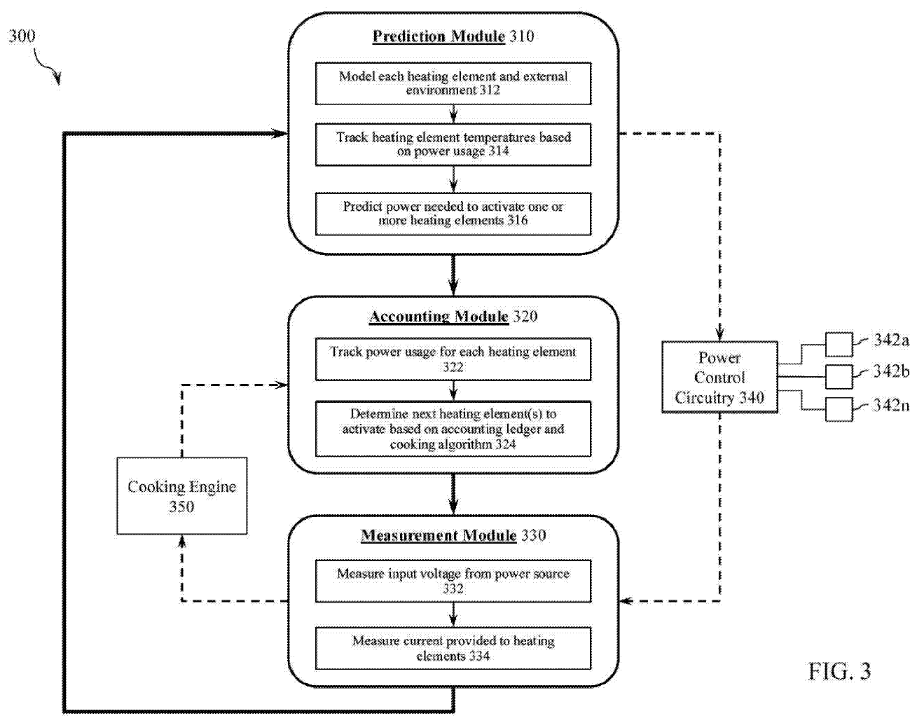

Referring to FIG. 3, an operation of power control logic 300, in accordance with various embodiments, will now be described. In various embodiments, the power control logic is operable to achieve a distribution of power balances amongst a set of heating elements at a time in the future (e.g., in 1 second). The power control logic determines how to optimally power the heating elements over the course of the corresponding time period to achieve the target distribution of power balances at the future time, while not violating electronic constraints (e.g., constraints of current draw through circuit breakers, power consumption constraints, etc.).

In the illustrated embodiment, the power control logic 300 includes a prediction module 310, an accounting module 320 and a measurement module 330. The modules 310, 320 and 330 may be implemented as a combination of one or more of analog circuitry, digital circuitry, dedicated hardware, and firmware/software providing instructions for execution by a processor. Further, it will be understood that the logical components described with reference to FIG. 3 are illustrative of only one embodiment of the principles of the present disclosure and that numerous modifications and alternative arrangements can be implemented in practice without departing from the spirit and scope of the present disclosure.

The prediction module 310 is operable to continually track modeled heating element temperatures to estimate the power to apply, as a function of time, to each of a plurality of heating elements 322a-n controlled by the power control circuitry 340 in order to optimally activate the heating elements to achieve a desired distribution of heater power balances while not violating electronic constraints (e.g., constraints of current draw through circuit breakers, power consumption constraints, etc.). In one embodiment, the prediction module 3101 models each heating element and its external environment (step 312), estimates heating element temperatures based on the historical power usage (step 314), and predicts the power to apply to one or more heating elements (step 316) based on the estimated temperature.

Each heating element (or other power consuming component) may have one or more known power consumption characteristics that may be modeled by the prediction module 310 to predict power consumption. The consumption characteristic may pose operational limitations on the systems and application of electrical power. In various embodiments, the electrical power characteristic may include, but are not limited to, instantaneous power draw, instantaneous current draw, steady-state power draw, and steady-state current draw of the electrical power consuming components.

Further characteristics of electrical power consuming components may include, but are not limited to, time dependent consumption characteristics, consumption characteristics based on external influences such as temperature or magnetic field, characteristics based on instantaneously supplied functions of voltage and current, characteristics based on steady-state supplied functions of current and voltage, characteristics based on a combination of instantaneous previously supplied functions of current and voltage, characteristics based on variable energy conversion, and age dependent consumption characteristics.

In various embodiments, the filament temperatures for each heating element are modeled as a ratio of the steady-state ohms (for the steady-state at maximum power) to instantaneous ohms (e.g., Q[steady-state]/Ω[instantaneous]), which may be referred to herein as a “steady-state conductance ratio.” The steady-state conductance ratio provides an instantaneous approximation of the anticipated power draw for activating each heating element. When a heating element is activated, the modeled conductance ratio for the heater decreases towards 1. At the same time, the steady-state conductance ratio of other heaters that are not activated will rise towards a “cold” maximum for each heater. The rate at which the steady-state conductance ratio changes for a given heater can be determined using multiple factors which are considered in the modeling, such as the physical behavior of the QTH heaters, the cooking chamber thermodynamics and other factors which may be determined in a test environment. The parameters associated with the modeled heater are tuned to the operating environment, including the types of heating elements used and characteristics of the oven.

In one embodiment, the prediction module 310 is operable to estimate how much power each heating element would consume if it was activated in the next half-cycle. The estimate is a function of the modeled filament temperature and other modeled physical properties, which is used to determine a phase-angle (ϕ) for triggering a corresponding switch (e.g., a TRIAC), for example, from 0. . . π, where the section of the half-cycle after the trigger point until the next zero-crossing (point at which the supply AC waveform voltage crosses zero volts) is the time that the switch applies power to its respective heating element. In addition to per-heating element filament temperature modeling, the prediction module 310 can use other factors based on the geometry and physics of the oven to more accurately model expected heating, cooling rates as well as anticipating reflection of emitted energy back into the heater based on whether or not an opaque tray is loaded into the cooking chamber.

The accounting module 320 is operable to estimate the current and power to apply to each heating element and the order of activation. In one embodiment, each half-cycle of the input AC (e.g., 100 Hz for 50 Hz countries or 120 Hz for 60 Hz countries), zero or one or more heating elements may be activated. Each half-cycle, actual consumed power is measured and attributed (added) to the power accounting ledger of each respective heating element (if any) that was triggered during that half-cycle (step 322). The next heating element(s) to activate are then determined based on the accounting ledger and the cooking algorithm (from cooking engine 350) to be implemented (step 324). In one embodiment, at the beginning of the next half-cycle, the heating element with the lowest accounted power value is selected as the heating element to activate.

The phase-angle for that activation may be determined from the prediction module 310 such that heating elements with low modeled filament temperatures (high conductance) are activated with shorter (lower-power) pulse periods and heaters with high modeled filament temperatures (low conductance) are activated with higher (higher-power) pulse periods. Additionally, secondary factors may be included in the selection process that consider the amount of thermal stress each heating element is subject to, invariant weighting such as treating top heaters differently than bottom ones or selecting heating elements based on separate cooking zones, considering the anticipated consecutive on-time of this activation, the instantaneous or average power-factor of the product or the anticipated electromagnetic emissions of the product resulting from each potential activation.

The measurement module 330 is operable to receive input voltage (step 332) and current measurements (step 334) from the power control circuitry 340. The measurement module 330 may receive the measured electrical voltage of the supply voltage of the AC input, and current measurement of the current flowing through the branch of the circuit which is common to the heaters. The measurement data is used by the prediction module 310 to estimate the temperature of each heating element based on the power usage. The measurement data is also used by the accounting module 320 to track the power usage for each heating element. In one embodiment, the measured input voltage is used by the cooking engine 350 and accounting module 320 to determine power available to be used by the heating elements.

Referring back to the prediction module 310, at any given instant, the prediction module 310 can predict which heating element and which phase-angle would result in the best utilization of available power without exceeding the power consumption limits for the oven or deviating too far from the target power level for each heating element. In one embodiment, this determination is made by solving for the phase-angle (until π) that gives an area under the curve equal to 1 as illustrated, for example, in FIG. 4C. For simplicity of illustration, FIG. 4C shows this type of solution for a half-sine curve, however other curves may be implemented including an ideal mathematical curve or a curve generated by measuring actual voltage waveforms. As illustrated, equal area sections of various magnitude half-sines are shown, with each overlapping shaded region having the same area (equal to one). This phase-angle can be used to compute the expected power consumed by each heating element given its instantaneous modeled conductance, which is a function of filament temperature and other factors. More complex functions to model power going to the heating elements may be used in other embodiments.

### Measurement and Heater Level Phase Control

As described herein, embodiments of variable phase control systems and methods determine an “on” time and/or an “off” time for each heating element to precisely control the power delivered to each heating element and to achieve accurate measurements of the current and/or voltage inbound to the device. In various embodiments, absolute and/or relative measurement errors may arise from one or more different causes. For example, in various embodiments, the heating elements are powered by TRIACs, which are capable of rapidly powering on and off This rapid switching also generates distortion/ringing in the electrical circuit that can lead to substantial measurement errors if a measurement is taken when the amplitudes of distortion/ringing are relatively large. In some embodiments, a worst-case duration of relatively large distortion/ringing amplitudes can be determined by devices such as oscilloscopes. That duration can be used as a parameter in the phase control system to offset a phase-angle at which a heater is activated, whereby such offset is away from the range of phase-angles at which the large distortion/ringing amplitudes would lead to substantial measurement errors. In some embodiments, when the input voltage is near zero, the corresponding current draw will also be near zero, which can lead to high relative errors in measurements due to quantization during digitization and/or variances in electronic components. In various embodiments, when the heating algorithm's requested power from the power source is low, the phase-angle at which the heater would naturally be activated to achieve such power may lead to measurements dominated by low voltages and currents. At such low voltages and currents, signal-to-noise ratios for voltage and current measurements would tend to be relatively low, leading to measurement errors.

In various embodiments, a variable phase control process can power the load in a way that reduces absolute and/or relative measurement errors. In one or more embodiments, the heating elements are controlled such that measurements are made at times that are selected to reduce such errors. In some embodiments, the measurements are performed at fixed times and the timing for powering the heating elements is varied. In those embodiments, a heating element may be powered earlier than the executing heating algorithm would otherwise indicate the heating element ought to be powered, to ensure that measurement of the inbound voltage and/or current is taken at a time when measurement errors are reduced (e.g. when ringing is no longer as disruptive to measurements, or when it would be advantageous to measure at a higher input voltage).

The accounting module 320 compensates for the early activation of the heating element in the next half wave. Thus, if the heating element is turned on early to allow for a “clean” measurement (i.e. where absolute and/or relative measurement errors are reduced), the heating element may be driven to be underpowered the next half cycle to compensate. For example, if the phase control system activates a heater at 160 degrees, the measurement may have a low signal-to-noise ratio and therefore greater measurement error (e.g., measurement error due to voltage offset). One solution is for the phase control system to activate a heater early to get a clean measurement and then compensate at the next half wave. But early activation may result in overpowering the heater in a given half wave, relative to the heater power level that the heating algorithm calls for in such half wave. In this manner, the system may overpower the heating element in one half wave, and then compensate for this overpowering by electing to underpower the heater in the next half wave to maintain a desired power output.

In some embodiments, where rapid on-and-off switching of power generates distortion/ringing in the electrical circuit that can lead to substantial measurement errors, the duration of the distortion may be too long to be avoided by the early powering of the heating elements as described above. When certain portions of the electrical waveform are subject to distortions or noise, the phase control system can extrapolate from other parts of the waveform to calculate the actual applied power. In some embodiments, the system takes a later measurement and extrapolates backward in time (e.g., by integrating the voltage, current and/or power sinusoidal curve) to a moment when the heating element was turned on. For example, a heating element may be turned on at a 40-degree phase-angle and a measurement may be taken at 45-degrees. The value of the voltage at the point of the sinusoidal wave going backward in time (i.e., the time corresponding to the 40-degree phase-angle) can be extrapolated there from. It is common when making electrical measurements to report the RMS, average of a measured quantity. For example, the RMS value of U.S. household voltage may be 120 Volts. Calculating an RMS value generally involves an integration or summing operation. Some electrical sources have variable frequencies making it difficult to calculate RMS values. The phase control system can include logic to track these changes in frequency to improve the accuracy of algorithms that calculate RMS values. In various embodiments, the tracking logic may be implemented as software and/or hardware in conjunction with implemented components of the prediction module 310.

In various embodiments, the phase control system can also be used to measure the electrical characteristics of the powered device for the purpose of detecting failures, degradations, or aging. For example, if the phase control system measures a non-zero voltage but a zero current, those measurements indicate that an electrical continuity failure is present.

In addition to reporting instantaneous measurements, it is sometimes advantageous for the system to report summed or integrated measurements to other system components, such as the cooking engine 350. For example, reporting summed or integrated measurements can be more resilient with respect to the absence of measurement values, which absence may arise due to loss data during transmission. For example, reporting sampled total consumed energy to other system components allows for the determination of average power using just the starting and ending energy values and the time between those reported samples, even if intermediate energy values are lost during reporting. Additionally, circuit breakers and similar devices often are sensitive to average current consumption over a multitude of time scales simultaneously. In some embodiments, integrated current can be used to determine average current usage over a variety of time scales to inform the power control system whether a circuit breaker has a high risk of tripping, which information enables the power control system to react by reducing power consumption.

### Design Considerations for Various Suboptimal Conditions

As previously described herein, a power control system with heater level phase control may maintain the desired power levels of inherently unstable loads, illustrated above as QTH heaters. In various embodiments, the system may also be able to do this under suboptimal conditions, such as when it is supplied with distorted AC power.

Distorted AC power is caused by a number of factors that are outside the control of the power control system, as well as the end customer using the product. Therefore, in some embodiments accurate and stable measurements are made with corresponding changes in the accounting and prediction modules of the power control system to compensate for non-sinusoidal voltage conditions.

For example, utility power may include frequency components beyond the fundamental frequency (50 Hz or 60 Hz). This may include combinations of third-order harmonics, fifth-order harmonics, higher-frequency components and net DC offsets. Additionally, spurious noise signals may be present in utility power that can, without mitigation, cause measurement error or malfunction. Referring to FIG. 4D, a graph illustrating exemplary distorted voltage waveforms that may be present on some buildings' circuits is provided. As illustrated, the solid line is a pure sine wave, the dotted line represents third-harmonic distortion, the dashed line represents fifth-harmonic distortion, and the dot-dashed line represents a combination of harmonic factors, such as under heavy reactive loading.

In various embodiments, the power control system may provide additional capabilities. For example, the system may change its parameters and limits automatically or based on user input to avoid blowing fuses or tripping breakers, at the potential cost of performance. Additionally, the system may be capable of detecting that it loses power during a cook—by failing to detect a zero-crossing in the expected time window—and, using remaining stored energy, can automatically adjust its limits down to avoid a repeat incident before energy reserves run out.

In view of the foregoing, advantages of the current system will be understood by those skilled in the art. The system addresses challenges of controlling heating elements, such as quartz-tungsten-halogen heaters. It is desirable to get the maximum power out of a wall socket and control the heating elements close to their power limits to compensate for inherent limits and deficiencies. Operating an oven with QTH heaters and conventional power control circuitry could produce undesirable results when the oven is trying to extract maximum power, such as blowing a fuse, tripping a circuit breaker, flicker or dimming of household lights or other shared electronics in the environment. In various embodiments, it is desirable to produce a fast, high performance oven that maximizes the current budget afforded to a consumer device (e.g., a 15 amp budget afforded by conventional circuits). Because one goal is a fast, high performance oven, and it is desirable to use the full allotment of the 15 amp budget available to the oven, a conventional power control scheme will cause big gulps of current to flow out of the outlet, which can cause lights to dim as household voltage decreases. The control scheme described herein prevents these large gulps from occurring.

The present disclosure also addresses other issues with the external environment such as poor wiring from the power source (e.g., a home residence), and distance of power line from breaker box and outlet, which will affect the input voltage received from the outlet. A shorter cable can lead to higher surge currents and a greater likelihood of tripping a breaker. A longer cable can lead to lower voltage and performance. The power control systems disclosed herein tracks the available input voltage to regulate the current spikes and allocate the available current to the heating elements, which mitigates these problems associated with variable voltages. The measurement components and modules may also measure the external environmental factors that may limit operation of the device.

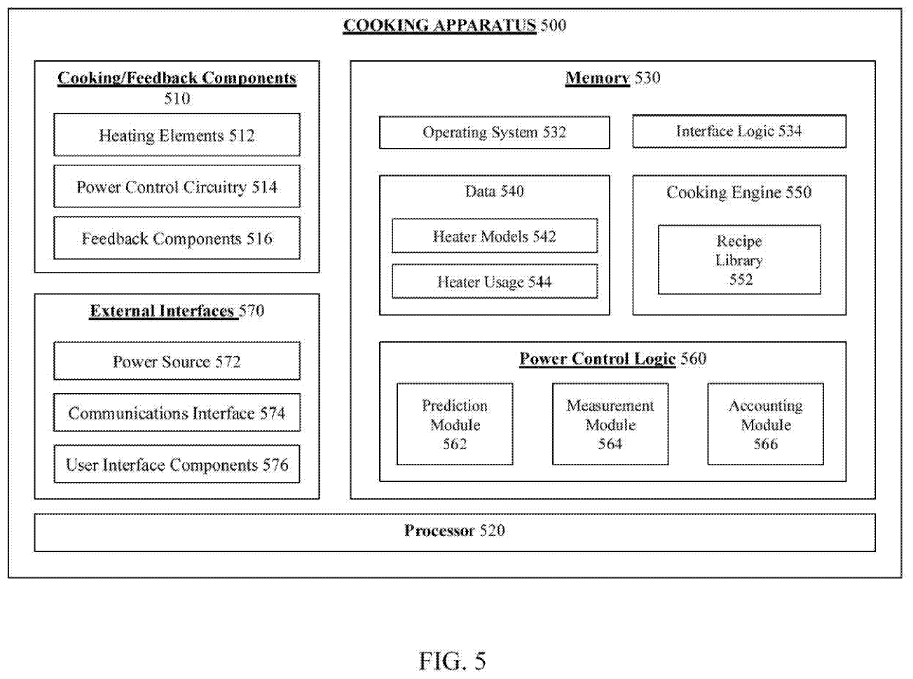

Referring to FIG. 5, an exemplary implementation of a cooking apparatus using the power control systems and methods of the present disclosure will now be described. A cooking apparatus 500 includes cooking and feedback components 510, a processor 520, memory 530 and external interfaces 570. Other hardware and software components may be included in various embodiments.

The cooking and feedback components 510 include heating elements 512, power control circuitry 514 and feedback components 516. The heating elements 512 include controllable heating elements, such QTH heating elements as described herein. In one embodiment, the heating elements 512 are wavelength controllable and include quartz tubes, each enclosing one or more heating filaments. The power control circuitry 514 includes circuit components for measuring voltage and current, driving the heating elements and performing other functions as described herein, and may include a plurality of TRIACs for driving the heating elements 512.

In various embodiments, the feedback components 516 include one or more cameras, probes and sensors providing real-time feedback during the cooking process. In one embodiment, the cooking engine 550 can receive one or more continuous feeds of temperature readings from a temperature probe or other sensors. In response to changes to the temperature readings from the continuous feeds, the cooking engine can execute a heat adjustment algorithm that is dynamically controlled by the cooking engine 550. The power control circuitry 514 will then activate the heating elements 512 to achieve the new heating objectives. In various embodiments, accounting module 566 determines the next heating element(s) to activate based on the heater usage 544 (e.g., an accounting ledger as described herein) and the updated heat adjustment algorithm.

The processor 520 controls the operation of the cooking apparatus 500, including executing various functional components, such as the components represented in memory 530. For example, the memory 530 can store program instructions for execution by the processor 520, which may include an operating system 532, interface logic 534, a cooking engine 550 and power control logic 560. The cooking engine 550 controls the cooking and feedback components 510, including the heating elements 512, through cooking logic and heating algorithms to implement a recipe (such as a recipe stored in recipe library 552). In various embodiments, data storage 540 stores configuration, recipe, cooking logic, food characterizations, and system information. The data storage 540 also stores heater models 542 for use by prediction module 562 and heater usage data 544 for use by accounting module 566.

Power control logic 560 includes a prediction module 562, measurement module 564 and accounting module 566, which include instructions for causing the processor 520 to perform an embodiment of one or more of the prediction, measurement and accounting functions described herein. The system may include various control capabilities including, but not limited to, producing a time dependent consumption function, maximizing the rate of change in consumption or energy conversion, optimizing current consumption, optimizing power consumption, anticipating hardware or software driven changes in electrical power consumption requirements, compensating for external supply characteristics including time dependent changes, coordinating with or influencing external electrical consumers, user control, providing telemetry, providing data used by control systems, measuring, optimizing and anticipating electrical component lifetimes, and providing information regarding energy conversion characteristics. In various embodiments, operational challenges can include system safety, circuit missed circuit breaker interaction, Thevenin equivalent resistances, source characteristics, and rapid control changes.

The external interfaces 570 include a power source 572 for connecting the cooking apparatus to an external power supply, a communications interface 574 for communicating with one or more other devices and user interface components 576. The power source 572 provides the power necessary to operate the physical components of the cooking apparatus 500. For example, the power source 572 can convert alternating current (AC) power to direct current (DC) power for the physical components. In some embodiments, the power source 572 can run a first powertrain to heating elements 512 and a second powertrain to the other components. It will be appreciated that the various components of the cooking apparatus 500 draw available power from a power source, which may impact the power available to the heating elements 512. In one embodiment, the power control logic 560 further estimates the power used by the various components of the cooking apparatus 500 when determining power available for use by the heating elements 512.

Components (e.g., physical or functional) associated with the cooking apparatus 500 can be implemented as devices, modules, circuitry, firmware, software, or other functional instructions. For example, the functional components can be implemented across one or more components in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the components may operate individually and independently of other components. Some or all of the components may be executed on the same host device or on separate devices. The separate devices can be coupled through one or more communication channels (e.g., wireless or wired channel) to coordinate their operations. Some or all of the components may be combined as one component. A single component may be divided into sub-components, each sub-component performing separate method step or method steps of the single component.

In some embodiments, at least some of the components share access to a memory space. For example, one component may access data accessed by or transformed by another component. The components may be considered “coupled” to one another if they share a physical connection or a virtual connection, directly or indirectly, allowing data accessed or modified by one component to be accessed in another component. In some embodiments, at least some of the components can be upgraded or modified remotely (e.g., by reconfiguring executable instructions that implements a portion of the functional components). The systems, engines, or devices described herein may include additional, fewer, or different components for various applications.

Referring now to FIG. 6, another embodiment of the present disclosure will now be described. In an embodiment previously described herein with reference to FIG. 1, an oven includes six heating elements, arranged with three elements on top and three on the bottom. It will be appreciated by those skilled in the art that other heating arrangements may be used including a different number of heating elements, disposing the heating elements at different location in the oven, and implementing different types of heating elements. FIG. 6 is a top view of a cooking apparatus including four heating elements on the top of the oven's interior cooking chamber, which may be virtually separated into target cooking zones. In this manner, the operation of each heating element 602A-D may be operated independently to cooking food in different zones in accordance with a cooking algorithm.

In some embodiments, the cooking apparatus may cook multiple dishes at the same time in difference cooking zones, with each dish having one or more associated temperature probes. The cooking apparatus may verify the proper cooking zone of each dish by monitoring the sensed heat in each zone or through other feedback components. In one embodiment, the multi-zone cooking apparatus flashes the heating elements in each zone and monitors the temperature sensing elements to automatically determine the zone associated with each recipe. The cooking algorithm, including heating elements associated with active cooking zones is provided to the power control logic to further select the heating elements to meet a heating objective for a certain zone.

The foregoing disclosure and the embodiments are not intended to limit the present disclosure to the precise forms or particular fields of use disclosed. As such, it is contemplated that various alternate embodiments and/or modifications to the present disclosure, whether explicitly described or implied herein, are possible in light of the disclosure. Some embodiments of the disclosure have other aspects, elements, features, and steps in addition to or in place of what is described above. These potential additions and replacements are described throughout the rest of the specification. Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be required for some embodiments but not other embodiments.

While some embodiments of the disclosure include processes or methods presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

In various embodiments, a method comprises regulating electrical power received from a power source, receiving at least one performance objective for a plurality of electrical power consuming components (e.g., heating elements, which may include quartz-tungsten-halogen heaters), and selectively delivering the electrical power to the plurality of electrical power consuming components to achieve the performance objective. The performance objective may comprise heating an interior oven chamber in accordance with a heating algorithm.

In various embodiments, a system comprises a cooking apparatus including a plurality of heating elements (e.g., quartz-tungsten-halogen heaters) operable to heat an interior chamber of the cooking apparatus to cook an edible substance, a cooking engine operable to implement a heating algorithm to control the heating element, and a power control system operable to receive electrical power from an external resource and allocate the received electrical power to implement the heating algorithm. In some embodiments, the power control system includes power control logic comprising a prediction module operable to predict electrical power to apply to one or more of the heating elements, a measurement module operable to measure voltage received from the external resource and measure a current provided to one or more of the heating elements, and an accounting module operable to track power usage or each of the plurality of heating elements and select one of the plurality of heating elements for activation. In some embodiments, the power control system is further operable to regulate received electrical power in accordance with system or external power constraints. In some embodiments, the power control system further comprises power control circuitry including a plurality of TRIACs, wherein each TRIAC is operable to activate a corresponding one of the plurality of heating elements.

In various embodiments, a cooking apparatus comprises a housing, an interior cooking chamber formed within the housing, a door providing access to the interior cooking chamber, a plurality of heating elements (e.g., quartz-tungsten-halogen heaters) operable to heat the interior cooking chamber; and power control logic and circuitry disposed within the housing and operable to selectively control the plurality of heating elements during operation of the cooking apparatus; wherein the power control logic and circuitry regulates power delivery to the plurality heating elements in accordance with a heating algorithm. In some embodiments, the cooking apparatus further comprises a power source interface operable to receive electrical power from an external power resource. In some embodiments, the power control logic and circuitry further regulates power delivery to the plurality heating elements in accordance power constraints of the cooking apparatus and/or external power resources.

In various embodiments, a power control system comprises one or more of a power input operable to receive electrical power from an external resource, a plurality of heating elements, and a processor operable to selectively apply the received electrical power to one or more of the heating elements in accordance with power control logic. The power control logic may comprise a prediction module operable to predict electrical power to apply to one or more of the plurality of heating elements, a measurement module operable to measure voltage received from the external resource and measure a current provided to one or more of the heating elements, and an accounting module operable to track power usage or each of the plurality of heating elements and select one of the plurality of heating elements for activation.

The power control system may further comprise a voltage sense network for sensing the received electrical power, a high-power current-sense resistor operable to sense current flow through a circuit path supplying power to the plurality of heating element, and/or a plurality of TRIACs. Each TRIAC may be electrically coupled to a corresponding one of the plurality of heating elements, and the processor may be further operable to generate TRIAC drive control signals to selectively activate one of the plurality of TRIACs to drive a corresponding heating element. The accounting module may be further operable to maintain a ledger of power usage for each heating element, update the ledger every half cycle and determine, using the ledger, a next one or more of the plurality of heating elements to activate. The prediction module may be further operable to model a temperature of each heating element and estimate a temperature of each heating element using the model and power usage.

Some embodiments of the disclosure have other aspects, elements, features, and steps in addition to or in place of what is described above. These potential additions and replacements are described throughout the rest of the specification. Having thus described embodiments of the present disclosure, persons of ordinary skill in the art will recognize that changes may be made in form and detail without departing from the scope of the present disclosure.

What is claimed is:

1. A device comprising:
a processor operable to execute power control logic configured to selectively apply electrical power received from an external resource to a plurality of heating elements to implement a heating algorithm, the power control logic further configured to:
measure the electrical power supplied to the plurality of heating elements;
predict an amount of the electrical power needed to activate one or more of the plurality of heating elements;
track power usage for each of the plurality of heating elements; and
determine a next heating element to activate based on the tracked power usage and the heating algorithm.

2. The device of claim 1 further comprising a voltage sense network operable to sense the electrical power received from the external resource; and
wherein the electrical power supplied to the plurality of heating elements is measured from the sensed electrical power received from the external resource.

3. The device of claim 1 further comprising a high-power current-sense resistor operable to sense current flow through a circuit path supplying power to the plurality of heating elements; and
wherein the electrical power supplied to the plurality of heating elements is measured from the sensed current flow.

4. The device of claim 1 further comprising a cooking engine operable to implement the heating algorithm to control the heating elements.

5. The device of claim 1 wherein the power control logic is further configured to track a temperature of each of the plurality of heating elements based on the measured electrical power; and
wherein the predicted amount of the electrical power needed to activate one or more of the plurality of heating elements is based on a difference between a current tracked temperature and a desired temperature established by the heating algorithm.

6. The device of claim 1 further comprising a plurality of TRIACs, each TRIAC electrically coupled to a corresponding one of the plurality of heating elements; and wherein the processor is further operable to generate TRIAC drive control signals to selectively activate one of the plurality of TRIACs to drive a corresponding heating element.

7. The device of claim 1 wherein the power control logic is further configured to:
maintain a ledger of power usage for each of the plurality of heating elements, wherein the ledger is updated every half cycle; and
determine, based on the ledger, a next one of the plurality of heating elements to activate.

8. The device of claim 1, wherein the power control logic is further configured to:
selectively power the heating elements in accordance with the heating algorithm to achieve a heating objective;
determine a time to measure the electrical power supplied to the plurality of heating elements;
supply power to the selected heating element at the determined time, wherein the determined time is different than an activation time for the selected heating element in accordance with the heating algorithm; and
adjust an amount of power supplied to the selected heating element in a subsequent cycle in accordance with the heating objective.

9. The device of claim 8, wherein measurement error varies during a heating cycle of the heating elements and the time to measure the electrical power is determined to reduce measurement error.

10. The device of claim 9, wherein the power control logic activates the selected heating element early in the heating cycle to get a measurement and compensates by reducing power applied in a next half cycle to maintain a desired power output.

11. The device of claim 9, wherein execution of the heating algorithm generates distortion in the measurements, and wherein the power control logic is further configured to take a measurement later in a cycle and extrapolate backward in time to a moment when the heating element was turned on.

12. The device of claim 1, wherein the power control logic is further configured to:
predict, based on measured power, a probability of a failure event; and
reduce power consumption in response to the predicted failure event

13. A method comprising:
regulating electrical power received from a power source;
receiving at least one performance objective for a plurality of electrical power consuming components; and
selectively delivering the electrical power to the plurality of electrical power consuming components to achieve the performance objective.

14. The method of claim 13 wherein the electrical power consuming components comprise a plurality of heating elements, and the performance objective comprises heating an interior oven chamber in accordance with a heating algorithm.

15. The method of claim 13 further comprising:
measuring the electrical power supplied to the plurality of electrical power consuming components;
predicting an amount of the electrical power needed to activate one or more of the plurality of electrical power consuming components;
tracking power usage for each of the plurality of electrical power consuming components; and
determining a next of the plurality of power consuming components to activate based on the tracked power usage and the performance objective.

16. The method of claim 15 further comprising tracking a temperature of each of the plurality of electrical power consuming component based on the measured electrical power; and
wherein the predicted amount of the electrical power needed to activate one or more of the plurality of electrical power consuming components is based on a difference between a current tracked temperature and a desired temperature in accordance with the performance objective.

17. The method of claim 13 further comprising:
maintaining a ledger of power usage for each of the plurality of electrical power consuming components, wherein the ledger is updated every half cycle; and
determining, based on the ledger, a next one of the plurality of electrical power consuming components to activate.

18. The method of claim 13 further comprising:
selectively powering the electrical power consuming components in accordance with the performance objective;
determining a time to measure the electrical power supplied to the plurality of electrical power consuming components;
supplying power to the selected electrical power consuming components at the determined time, wherein the determined time is different than an activation time for the selected electrical power consuming components in accordance with the performance objective; and
adjusting an amount of power supplied to the selected electrical power consuming components in a subsequent cycle in accordance with the performance objective.

19. The method of claim 18, wherein measurement error varies during an activation cycle of the electrical power consuming components and the time to measure the electrical power is determined to reduce measurement error.

20. The method of claim 13 further comprising:
predicting, based on measured power, a probability of a failure event; and
reducing power consumption in response to the predicted probability of a failure event.
